(19) United States
(12) Patent Application Publication
(10) Pub. No.: US 2014/0341552 A1
(43) Pub. Date: Nov. 20, 2014

(54) Beverage Dispenser with Improved Flow Control and Thermal Control

(71) Applicant: ZPM Ltd. Co., Atlanta, GA (US)

(72) Inventors: Igor Zamlinksy, Roswell, GA (US); Gleb Polyakov, Atlanta, GA (US)

(73) Assignee: ZPM Ltd. Co., Atlanta, GA (US)

(21) Appl. No.: 13/894,324

(22) Filed: May 14, 2013

(51) Int. Cl. A47J 31/54; G05D 23/19; A47J 31/56

(52) U.S. Cl. CPC A47J 31/545; A47J 31/56; G05D 23/1927
USPC 392/484; 122/18.4; 219/494; 219/496

(57) ABSTRACT

An espresso machine with improved fluid and thermal control is disclosed. The machine can include a controller for feedback pressure control of vibratory solenoid pumps. The controller can monitor pump pressure and/or volume and provide real-time feedback control of the pump pressure and/or volume. The controller can control pump output by means of a direct current, variable frequency square wave, which can be regulated to maintain a desired pressure output. The controller can also control pump output by means of a direct current, variable pulse width square wave. The espresso machine can also include a thermoblock with improved thermal efficiency and temperature control. The thermoblock can comprise a one or more serpentine pathways to improve thermal transfer to the fluid therein. The thermoblock can also provide feedback control of the temperature of the fluid.

CROSS REFERENCE TO RELATED APPLICATIONS & PRIORITY CLAIM

This Application claims priority to and benefit under 35 USC §119(e) of U.S. Provisional Patent Application Ser. No. 61/608,000, entitled “Pump Control” and U.S. Provisional Patent Application Ser. No. 61/608,008, entitled “Heated Thermoblock,” both filed May 14, 2012, both of which are hereby incorporated by reference as if fully set forth below.

### BACKGROUND

1. Field of the Invention

Embodiments of the present invention relate generally to beverage dispensing machines, and more particularly to espresso machines with improved thermal and flow control.

2. Description of Related Art

Espresso machines, and other beverage dispensing machines, use a variety of pumps. Espresso machines, for example, include a relatively high pressure pump (˜15 Bar) to pump steam through coffee grounds. These pumps can be rotary vane pumps, for example, which use a plurality of vanes on a rotor. The rotor is then mounted offset in a circular chamber to create a pumping action as each vane moves from the “large” end of the pump to the “small” end of the pump creating pressure.

In other cases, these pumps can be vibratory solenoid pumps. Vibratory solenoid pumps in consumer or commercial applications, for example, generally consist of a solenoid coil-wrapped tube with a spring-tensioned shuttle and a check valve. As the name implies, as the shuttle vibrates back and forth in the tube displacing fluid. As the fluid is displaced, a check valve acts as a “diode” and maintains flow only in one direction.

Vibratory solenoid pumps are typically designed to be driven directly by an alternating current “mains” power supply. As shown in FIG. 1, therefore, a diode is sometimes placed in series with the solenoid to eliminate every other half cycle of the sine wave. Depending on configuration, each half cycle, or every other half cycle, of the drive signal actuates the shuttle-generating pressure.

These pumps operate based on the frequency of the power supply (e.g., 60 Hz) and thus, operate at a constant actuation rate and constant pressure. In addition, active pressure control for solenoid pumps is uncommon. Some existing systems use triodes for alternating current (TRIACs), for example, to switch the alternating current. Unfortunately, these systems tend to be unstable, unreliable, provide limited control, and are complicated.

In addition, home espresso machines (and some commercial machines) generally use one of two technologies to heat the water inside the machines before it is streamed under pressure over coffee grounds or exhausted as steam: boilers and thermoblocks. As the name implies, a boiler is simply a vessel with a heat source (e.g., heating element or gas flame) to heat the water. A thermoblock, on the other hand, is a large block of metal with a plurality of narrow channels that acts like a heat exchanger. A heating element heats the thermoblock, which heats the water by transferring heat to the liquid from the metal via conduction as the water flows through the channels.

FIG. 2 depicts the fluid circuit for a commercially available espresso machine. The machines generally comprise a water tank 205 and a vibratory or rotary vane pump 210 to deliver water and/or steam to the dispenser 215. As described above, however, a problem with conventional pumps 210 used in espresso and other dispensing machines is that they do not provide variable pressure control. As a result, return circuits 220, pressure relief valves 225, and other systems must be used to return excess flow to the water tank 205. This unnecessarily complicates the machine and wastes energy because the pump 210 pumps more water than is necessary, which is simply returned to the tank 205.

Unfortunately, conventional thermoblock designs tend to perform poorly due to, among other things, the small contact area between the water and the thermoblock, underpowered heating elements, and low thermoblock mass. These factors conspire to lower the efficiency of the conduction between the metal of the block and the water. This results in poor temperature control (among other things), which is key to quality espresso.

What is needed, therefore, is an espresso machine that provides improved pump control for improved control over drink quality and improved service life and efficiency. What is also needed is a thermoblock with improved thermal transfer to improve heat transfer efficiency and temperature control. It is to such a machine that embodiments of the present invention are primarily directed.

### SUMMARY OF THE INVENTION

The present invention is a method for feedback pressure control of vibratory solenoid pumps, particularly in applications for beverage extraction and dispensation. This method forgoes the typical fixed frequency alternating current sine wave drive signal, instead utilizing a direct current, variable frequency square wave. Using feedback control, the frequency of said square wave can be regulated to maintain a desired pressure output.

The present invention is a solid block water heater with integrated brew group and filter holder; whose channel design allow it to heat water to a consistent temperature for the duration of an espresso shot, as well as produce steam when required. It is comprised of a block with serpentine concentric water channels, a steam channel, a spring operated check valve, an internal heating element, and filter holder.

Embodiments of the present invention also enable consistent pressure and temperature and variable pressure and temperature profiles. In some embodiments, pressure can be ramped up or down through the duration of the shot, for example, temperature can be ramped up or down through the duration of the shot, or any combination thereof.

Embodiments of the present invention can comprise a system including a pump in fluid communication with a fluid from a fluid supply and a thermoblock. In some embodiments, the thermoblock can comprise a fluid inlet, a fluid outlet, one or more fluid passages, disposed in fluid communication with the fluid inlet and the fluid outlet, in a serpentine configuration, and a thermal source in thermal communication with the one or more fluid passages to change the temperature of the fluid as is passes through the one or more fluid passages. In some embodiments, the thermoblock can also comprise a steam outlet, and a check valve with a first position and a second position. In this configuration, when the fluid is in liquid form, the check valve is in the first position and the one or more fluid passages are in fluid communication with the fluid outlet and, when the fluid is a gas, the check valve is in the second position and the one or more fluid passages are in fluid communication with the steam outlet.

In some embodiments, the thermal source can be, for example, a resistive heating element or a gas flame. In other embodiments, the pump can be a vibratory pump and the pump volume, pressure, or both are adjustable by varying the pump frequency or the pulse width. In some embodiments, the system can also include a temperature sensor in thermal communication with the thermoblock and a control unit for controlling the temperature of a fluid in the thermoblock. In some embodiments, the control unit can be a proportional-integral (PI) control unit.

Embodiments of the present invention can also comprise a system including a pump, with an inlet and an outlet, the inlet in fluid communication with a fluid supply, a thermoblock comprising a fluid inlet in fluid communication with the outlet of the pump, a fluid outlet, and a plurality of serpentine fluid passages between the inlet and the outlet, a thermal source, a pressure sensor in fluid communication with the outlet of the pump, a control unit in electrical communication with the pressure sensor and the pump for controlling the pressure at the outlet of the pump, and a thermal source in thermal communication with the thermoblock to change the temperature of the fluid as is passes through the thermoblock.

In some embodiments, the control unit can be a proportional-integral-derivative (PID) controller. In this configuration, the control unit can measure an error between a first setpoint and a pressure measured by the pressure sensor and change the frequency or pulse width of the pump to reduce the error. In some embodiments, the pressure transducer can comprise a piezoresistive ceramic pressure sensor. In some embodiments, the thermoblock can comprise aluminum.

In other embodiments, the thermoblock can further comprise a cover plate, a base plate comprising a heating element groove housing the thermal source, and a check valve with a first position and a second position. In this configuration, when the check valve is in the first position, the one or more fluid passages can be in fluid communication with a fluid outlet, and when the check valve is in the second position, the one or more fluid passages are in fluid communication with a steam outlet.

Other aspects and features of embodiments of the present disclosure will become apparent to those of ordinary skill in the art, upon reviewing the following detailed description in conjunction with the accompanying figures.

### BRIEF DESCRIPTION OF THE DRAWINGS

FIG. 1 depicts a conventional pump control signal.

FIG. 2 depicts a conventional water circuit for an espresso machine.

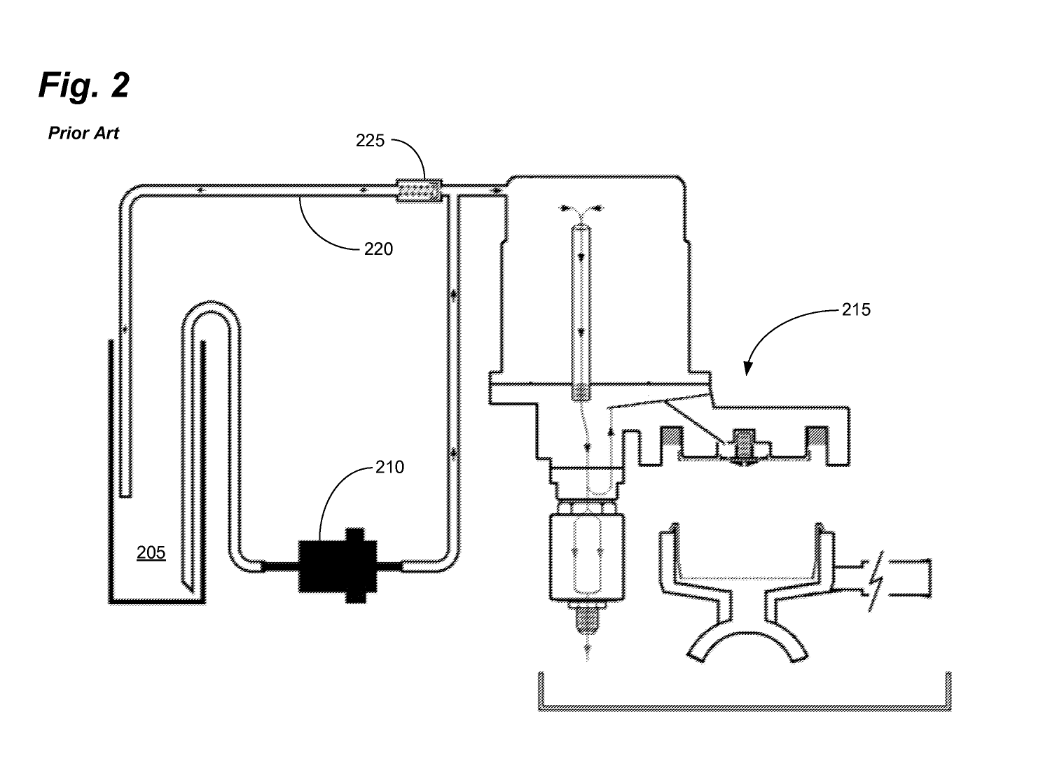

FIG. 3 depicts a square wave control signal, in accordance with some embodiments of the present invention.

FIG. 4 is a flowchart depicting a method of controlling pump pressure, in accordance with some embodiments of the present invention.

FIG. 5 is a perspective view of a thermoblock, in accordance with some embodiments of the present invention.

FIG. 6 is a top view of a thermoblock, in accordance with some embodiments of the present invention.

FIG. 7 is a bottom, perspective view of a thermoblock, in accordance with some embodiments of the present invention.

FIG. 8 is a bottom view of a thermoblock, in accordance with some embodiments of the present invention.

FIG. 9 is an exploded, perspective view of a thermoblock assembly, in accordance with some embodiments of the present invention.

FIG. 10 is another exploded, perspective view of a thermoblock assembly, in accordance with some embodiments of the present invention.

### DETAILED DESCRIPTION

Embodiments of the present invention relate to an espresso machine with improved fluid and thermal control. In some embodiments, the espresso machine can include a vibratory solenoid pump with improved pressure control. The machine can also include a thermoblock with increased surface contact area to provide improved efficiency and improved temperature control, among other things.

To simplify and clarify explanation, the system is described below as a motor and heat exchanger for an espresso machine. One skilled in the art will recognize, however, that the invention is not so limited. The system can also provide improved pumping for a number of fluids and in a number of applications including, but not limited to, coffee, soda, and other drink dispensers, sump pumps, fuel pumps, and washing machines. The system can also provide a heat exchanger with improved efficiency for use in, for example and not limitation, hot water dispensers, on demand hot water heaters, automotive heating and cooling systems, and pressure washers.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention.

As mentioned above, conventional espresso machines generally incorporate fixed pressure pumps. In addition, espresso machines tend to use poorly designed thermoblocks, or other heat exchangers, that provide inefficient heat transfer due to, among other things, the small contact area between the water and the thermoblock, underpowered heating elements, and low thermoblock mass. As a result, the heating systems cycles on and off, constantly under or over heating the water. Unfortunately, temperature control is critical to providing quality espresso and other hot beverages.

What is needed, therefore, is an espresso machine and pump that is simple and robust, yet provides variable pressure control. In addition, the espresso machine should have a thermoblock with improved efficiency and temperature control. It is to such a system that embodiments of the present invention are primarily directed.

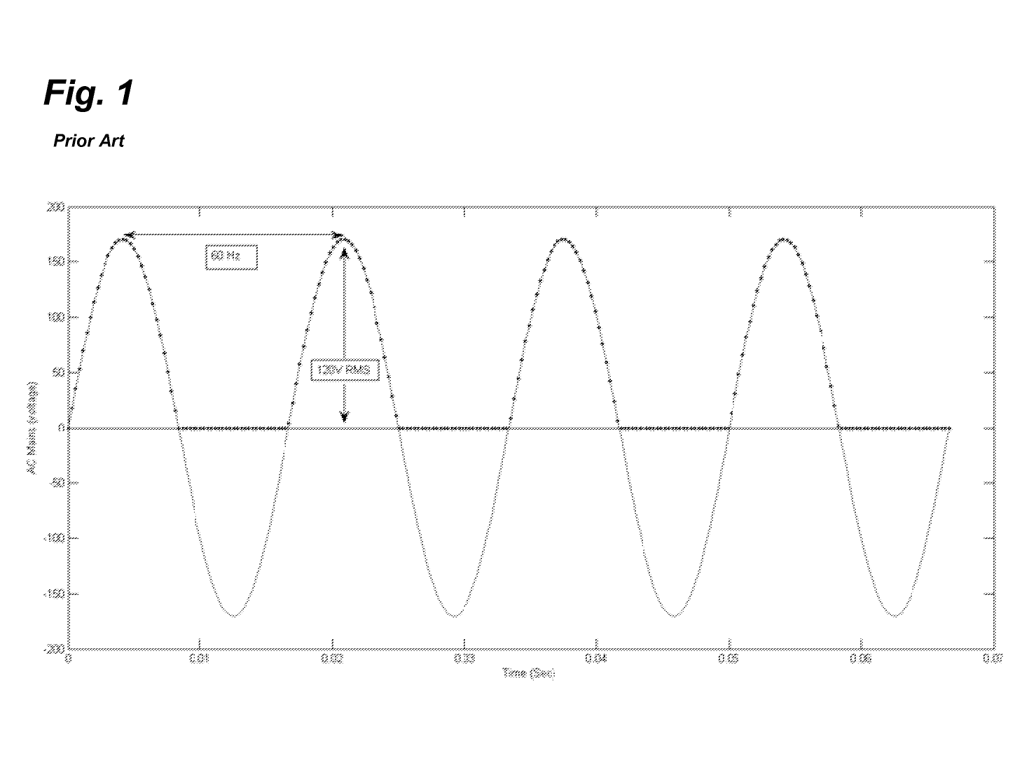

Embodiments of the present invention, therefore, relate to a vibratory pump with improved flow control. FIG. 1 depicts embodiments of the control system disclosed herein. In a vibratory pump, each actuation of the shuttle moves a set volume of water through the pump. The volume per actuation is determined by, among other things, the physical properties of the pump and the back pressure in the hydraulic system. When driven by AC mains power, however, the pump actuation rate is constant. As a result, the pump pressure is set by physical properties of the hydraulic system.

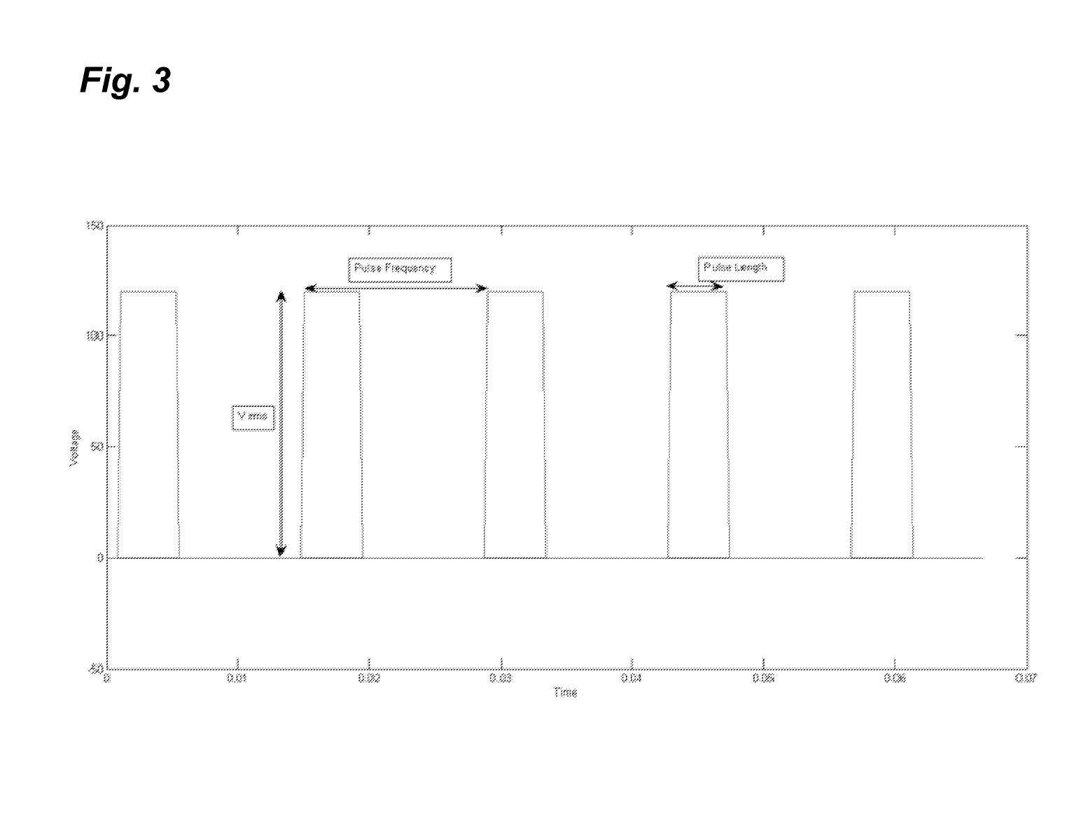

As mentioned above, it would be advantageous to control pressure in the system independently of system properties. In some embodiments, this can be achieved by controlling the pump actuation rate. In other words, lowering the pump actuation rate (frequency) lowers pressure and vice-versa. As shown in FIG. 3, in some embodiments, the pump can be driven using a direct current (DC) pulse. An example of a suitable pump is a ULKA EP5. Of course, other pumps can be used and are contemplated herein.

In this configuration, one pulse can cause one actuation of the pump. Using a microcontroller, for example, a square wave pulse can be generated and controlled precisely. In some embodiments, the pulse width can be kept constant. The pulse width can be sized such that the pulse is long enough to enable the pump to complete one actuation stroke and short enough to keep within the duty cycle limits of the pump. In this configuration, control of flow rate and pressure can be controlled by varying the pulse frequency controls. In some embodiments, the system can include a pressure sensor and/or a feedback control algorithm running on the microcontroller to monitor and adjust the pressure in the system at any point.

In other embodiments, the frequency can remain constant and the pulse width can vary. In this configuration, the frequency can be maintained at a constant and can be synchronized with the mains power (e.g., 60 Hz in the U.S.), for example. In this configuration, the pulse width can be varied infinitely between a first pulse width, i.e., the pulse width required for a full pump stroke (maximum output) and a second pulse width, or no pulse width (zero output). In this configuration, at a pulse width size between the first pulse width and the second pulse width, the pump operates on a partial stroke, adjusting pressure and volume. In still other embodiments, both pulse width and frequency can be varied to provide additional adjustability.

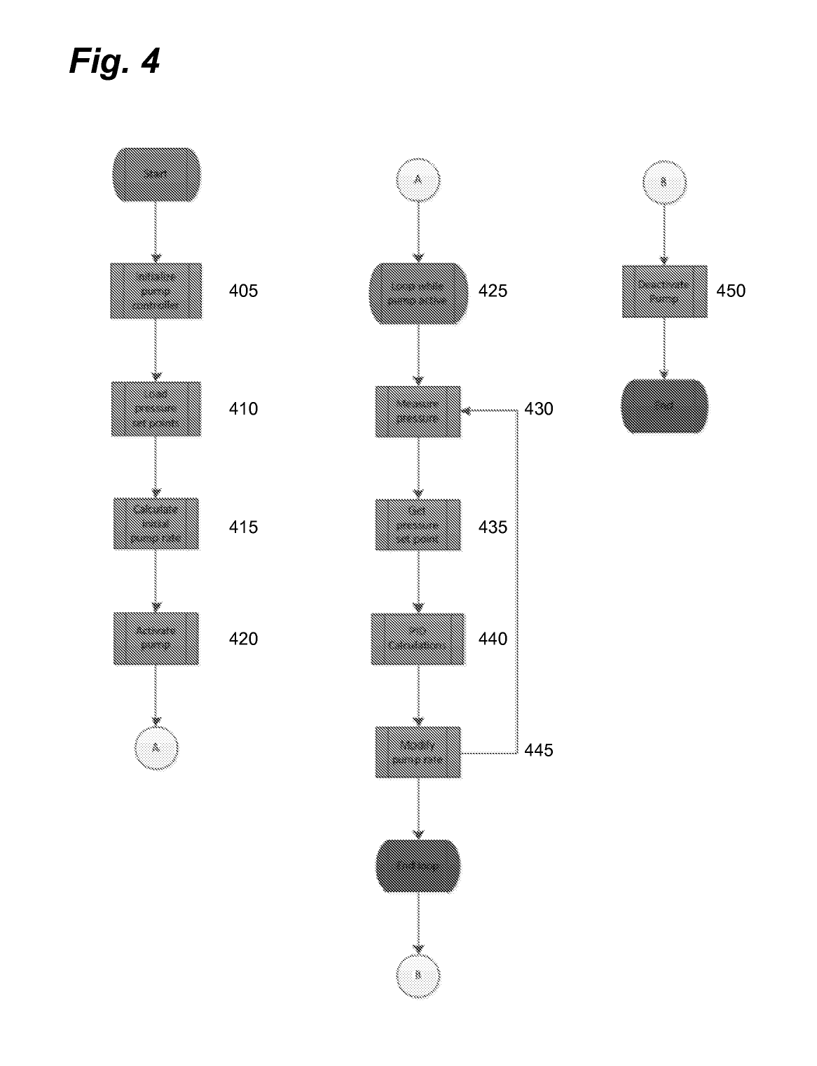

Embodiments of the present invention can also comprise a method for providing variable pump pressure with feedback. As shown in FIG. 4, in some embodiments a pump controller can be used. The controller can use one of a variety of types of feedback and non-feedback control including, but not limited to proportional-integral (PI), proportional-integral-derivative (PID), and simple on/off control. In some embodiments, a PID Controller can be used and the pump controller can be initialized 405 and can be provided with the desired pressure set point(s) 410. The pump controller can then calculate an initial, estimated pump rate 415 required to produce the commanded pressure. This can be done, for example, using a calculation or an onboard table to lookup pump rate. With the initial rate calculated, the pump can then be activated 420 using a pulsed signal, as described above, at the predetermined pump rate.

Because the output of the pump is affected by multiple variables including, but not limited to, inlet pressure, fluid temperature, pump temperature, and input voltage, in some embodiments the controller can employ feedback control. When the pump has been initialized 420, the controller can also initialize a feedback loop 425. The loop 425 can include, for example, a pressure measurement 430 using a pressure transducer, for example, or other suitable method. In some embodiments, a Metallux ME662 piezoresistive ceramic pressure sensor, or other suitable pressure transducer, can be used. The controller can then retrieve the pressure set point 435 and compare it to the measured pressure 430. In some embodiments, the controller can comprise a PID controller performing PID calculations 440 to provide a suitable feedback response. The response can then be used to modify the pump rate 445 to achieve the desired pressure. When pressure from the pump is no longer demanded, the pump can be deactivated 550.

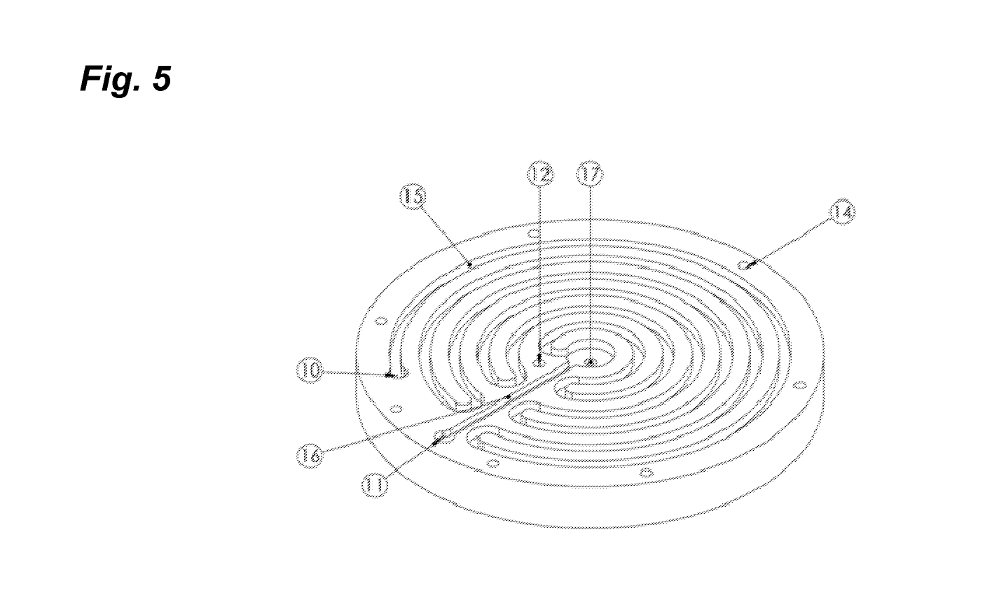

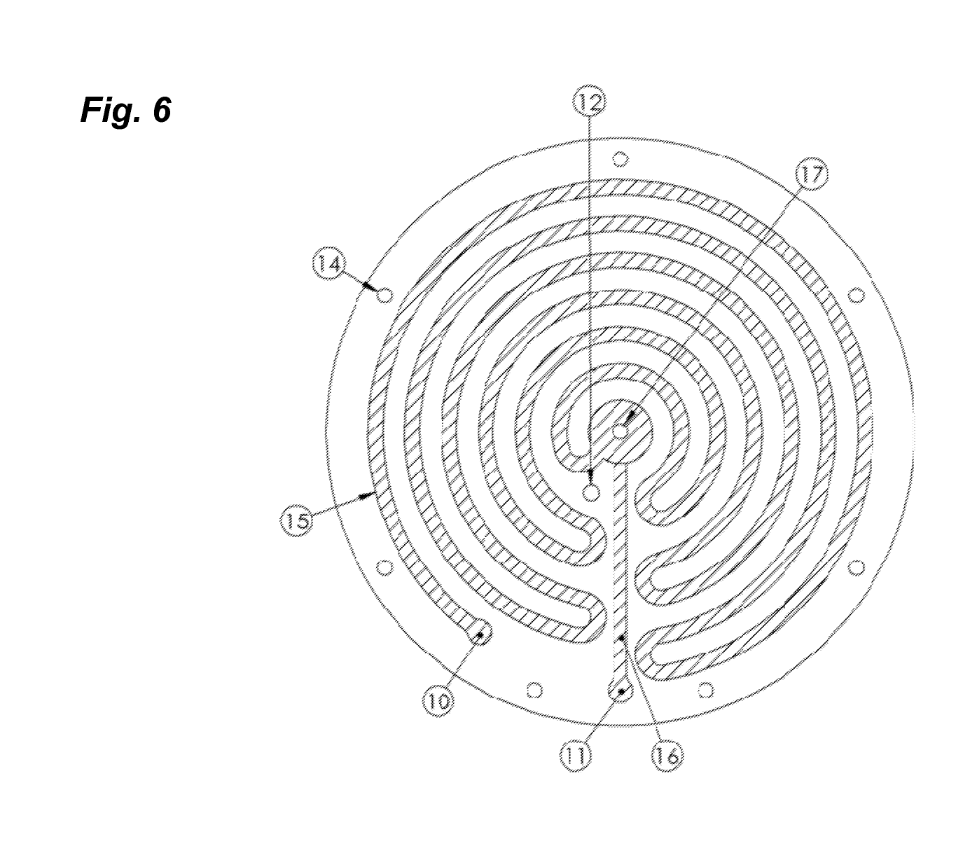

As shown in FIGS. 5 and 6, embodiments of the present invention can also comprise a thermoblock 500 for heating or cooling fluids with improved efficiency. As shown, the thermoblock 500 can comprise a plurality of the water channels 15 in a “labyrinth,” or serpentine, pattern. In some embodiments, the water supply inlet 10 can be in fluid communication with the water source (e.g., the pump 210) and can direct water into the plurality of water channels 15. In some embodiments, the channel 15 can be of sufficient length to raise the temperature of the water to the desired set point by the time it reaches the water outlet 17 at the center of the thermoblock 500. Of course, the inlet 10 and outlet locations 17 are somewhat arbitrary and could be reverse, for example, for packaging reasons.

In this configuration, when making steam (e.g., for making espressos), for example, as opposed to simply heating water for brewing, the water can travel through the plurality of water channels 15 at a lower rate than when brewing. This can be achieved using the aforementioned pump control 200, for example. At lower flow rates, the water can evaporate as it travels through the plurality of channels 15. Due to increased heat transfer, when the steam reaches the center 17 of the thermoblock 500, it can be diverted by the spring force of a check valve located in the outlet 17, and sent through a steam channel 16, and out through a steam outlet 11. The steam can then exit the machine through a steam valve (not shown) for use in steaming milk, for example, for beverages.

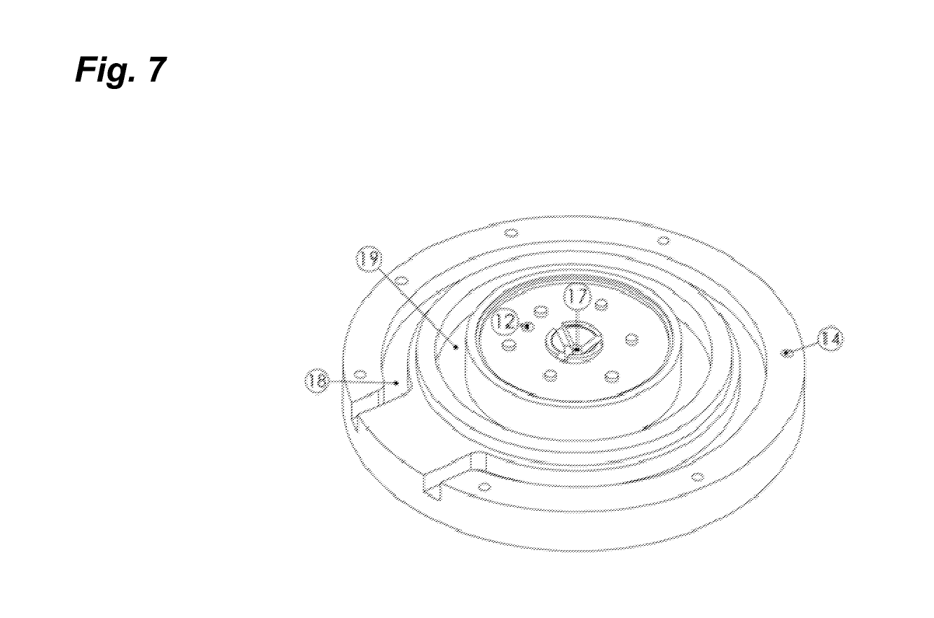

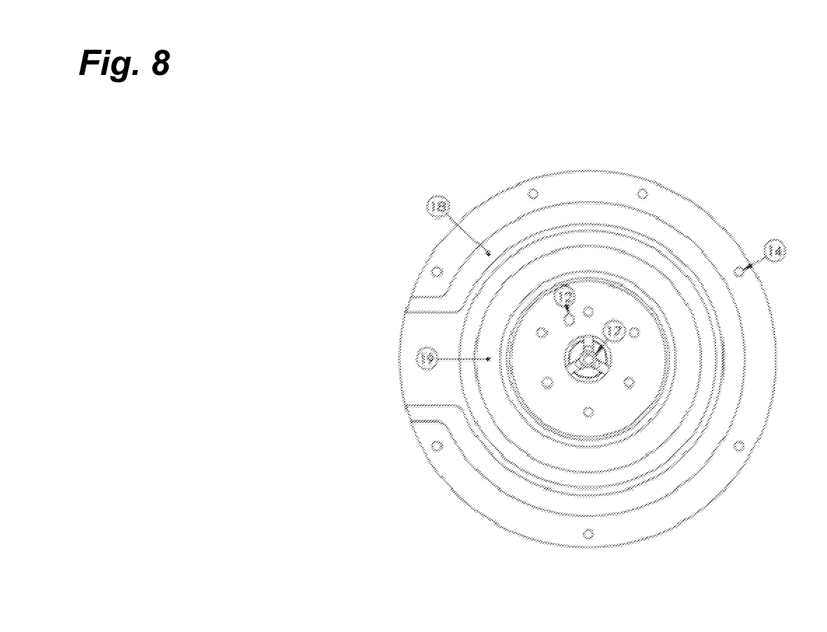

Referring now to FIGS. 7 and 8, the bottom of the heated thermoblock is shown including a heating element groove 18, which can house an internal heating element. The heating element can comprise one of many suitable heating element materials including, for example and not limitation, resistance wire (e.g., kanthal, nichrome, cupronickel, etc.), ceramic, or printed film technology. In a preferred embodiment, the thermoblock 500 can comprise a material with high thermal conductivity such as, for example and not limitation, brass, bronze, or copper. In some embodiments, the thermoblock can comprise aluminum and can be, for example and not limitation, A413 or 6061 Aluminum. In this manner, the heat from the heating element can be efficiently and evenly distributed to the fluid. In some embodiments, the thermoblock 500 can further comprise a gasket groove 19 and a brew gasket (not shown) to provide a watertight seal.

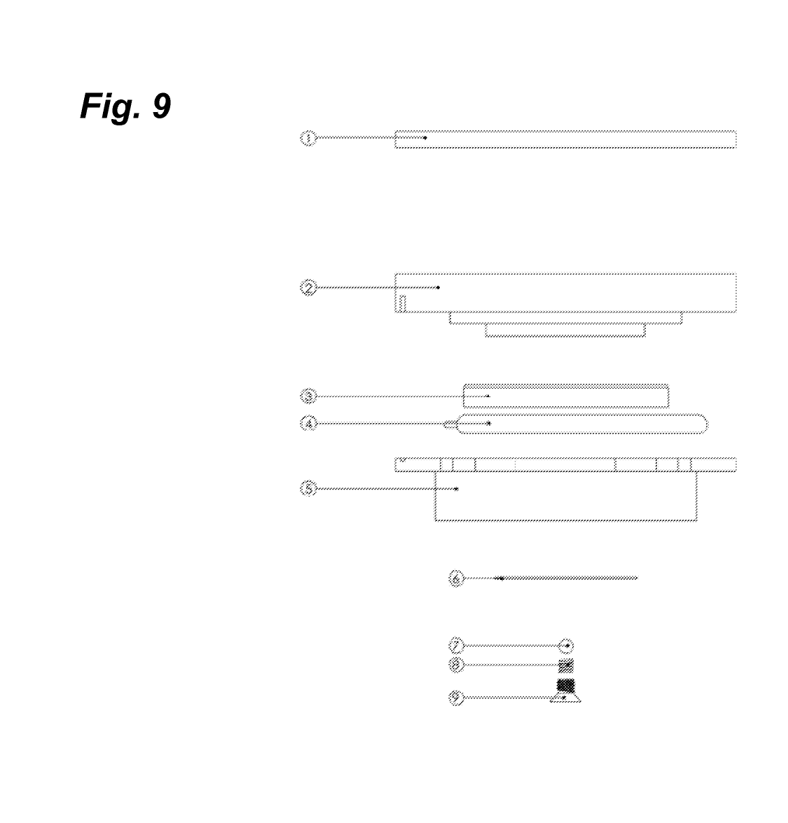

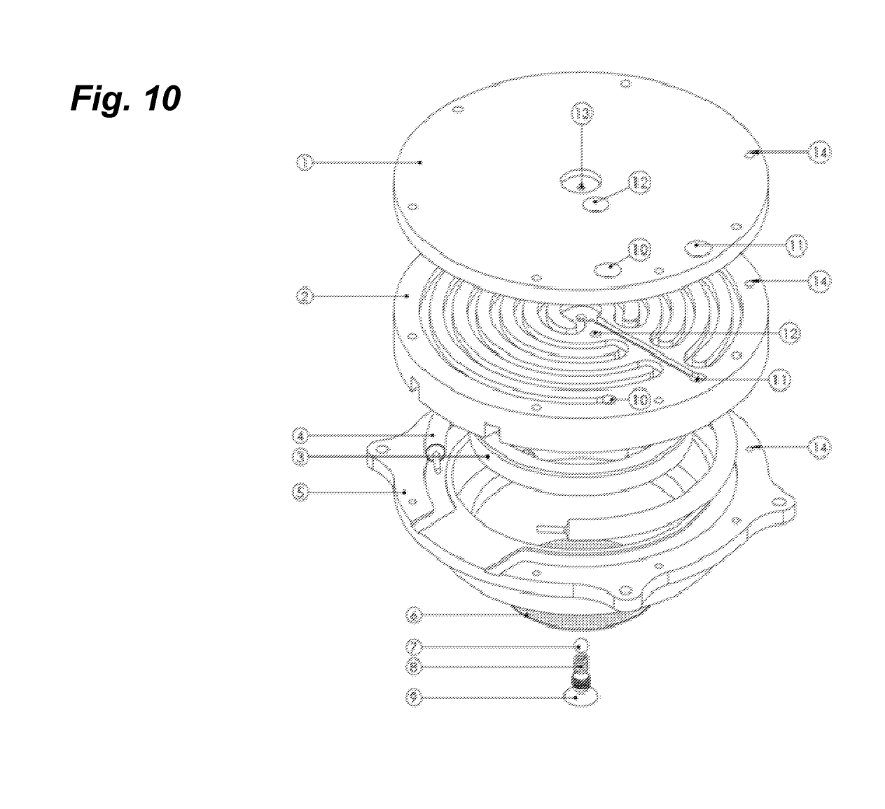

FIGS. 9 and 10 depict an exploded view of the thermoblock 2. As shown, the thermoblock 2 and heating element 4 can be disposed between the cover plate 1 and the base plate/filter holder 5. In some embodiments, the heating element 4 can be inserted into the heating element groove 19 and can be mechanically clamped between the thermoblock 2 and mounting block 5. In some embodiments, the assembly can be held together using fasteners and holes 14 around the perimeter of the block. The fasteners can comprise, for example and not limitation, bolts, screws, pins, or rivets. In some embodiments, the unit can also comprise a brew gasket 3 inserted into a gasket groove 19.

The thermoblock 500 can further comprise a check valve 20, which can be installed inside the brew water outlet 17. In a preferred embodiment, the check valve 20 can comprise a temperature rated, food grade rubber or plastic ball 7, a spring 8, and a retaining screw 9. In some embodiments, the check valve 20 can be adjustable with the retaining screw 9 setting the seat pressure of the check valve 20 by increasing or reducing spring 8 tension. In some embodiments, a distribution screen 6 can also be held in place using the retaining screw 9 of the check valve 20 to catch any particulate matter in the system (e.g., coffee grounds).

In some embodiments, the system can also comprise a temperature feedback loop. In this configuration, a temperature sensor can be attached to the thermoblock 500 at a mounting point 13 above the brew water outlet 17. As water exits the thermoblock 500, the temperature sensor can measure its temperature and provide feedback to the pump control. In this manner, the pump speed can be varied in real time to provide precise temperature control and the outlet 17. Temperature control can be achieved using a separate feedback loop, similar to the PID feedback controller discussed above, or can be achieved using a thermistor, thermocouple, mechanical thermostat, or other suitable means. In some embodiments, temperature control can be provided using a predictive semi-open feed forward PI-controller. As mentioned above, temperature control is important to drink quality.

While several possible embodiments are disclosed above, embodiments of the present invention are not so limited. For instance, while the pump and thermoblock disclosed above are discussed in conjunction with an espresso machine, the system could be used in many systems where efficient pumping and temperature control are desired. The final marketed “form” of the product could be, for example, espresso or other drink dispensing machines, machine cooling systems, or heating and air conditioning units. In addition, the system is discussed above with respect to fluids, but could also be used for gases or powders, for example, with little or no modification.

The specific configurations, choice of materials and chemicals, and the size and shape of various elements can be varied according to particular design specifications or constraints requiring a system or method constructed according to the principles of the invention. For example, while certain exemplary ranges have been provided for the application of boric acid, for example, other concentrations can be used in conjunction with different pesticides or in different regions. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system comprising:
a pump in fluid communication with a fluid from a fluid supply; and
a thermoblock comprising:
a fluid inlet;
a fluid outlet;
one or more fluid passages, disposed in fluid communication with the fluid inlet and the fluid outlet, in a serpentine configuration; and
a thermal source in thermal communication with the one or more fluid passages to change the temperature of the fluid as is passes through the one or more fluid passages.

2. The system of claim 1, the thermoblock further comprising:
a steam outlet; and
a check valve with a first position and a second position;
wherein, when the fluid is in liquid form, the check valve is in the first position and the one or more fluid passages are in fluid communication with the fluid outlet; and
wherein, when the fluid is a gas, the check valve is in the second position and the one or more fluid passages are in fluid communication with the steam outlet.

3. The system of claim 1, wherein the thermal source is a resistive heating element.

4. The system of claim 3, wherein the thermal source is a gas flame.

5. The system of claim 1, wherein the pump is a vibratory pump and the pump volume, pressure, or both is adjustable by varying the pump frequency.

6. The system of claim 1, wherein the pump is a vibratory pump and the pump volume, pressure, or both is adjustable by varying the pump pulse width.

7. The system of claim 1, further comprising:
a temperature sensor in thermal communication with the thermoblock; and
a control unit for controlling the temperature of a fluid in the thermoblock.

8. The system of claim 7, wherein the control unit is a proportional-integral (PI) control unit.

9. A system comprising:
a pump, with an inlet and an outlet, the inlet in fluid communication with a fluid supply;
a thermoblock comprising a fluid inlet in fluid communication with the outlet of the pump, a fluid outlet, and a plurality of serpentine fluid passages between the inlet and the outlet;
a thermal source;
a pressure sensor in fluid communication with the outlet of the pump;
a control unit in electrical communication with the pressure sensor and the pump for controlling the pressure at the outlet of the pump; and
a thermal source in thermal communication with the thermoblock to change the temperature of the fluid as is passes through the thermoblock.

10. The system of claim 9, wherein the control unit is a proportional-integral-derivative (PID) controller;
wherein the control unit measures an error between a first setpoint and a pressure measured by the pressure sensor; and
wherein the control unit changes the frequency of the pump to reduce the error.

11. The system of claim 9, wherein the control unit is a proportional-integral-derivative (PID) controller;
wherein the control unit measures an error between a first setpoint and a pressure measured by the pressure sensor; and
wherein the control unit changes the pulse width of the pump to reduce the error.

12. The system of claim 9, wherein the pressure transducer comprises a piezoresistive ceramic pressure sensor.

13. The system of claim 9, wherein the thermoblock comprises aluminum.

14. The system of claim 9, wherein the thermoblock further comprises:
a cover plate;
a base plate comprising a heating element groove housing the thermal source; and
a check valve with a first position and a second position;
wherein, when the check valve is in the first position, the one or more fluid passages are in fluid communication with a fluid outlet; and
wherein, when the check valve is in the second position, the one or more fluid passages are in fluid communication with a steam outlet.
